(19) United States
(12) Patent Application Publication
(10) Pub. No.: US 2018/0150752 A1
(43) Pub. Date: May 31, 2018

(54) IDENTIFYING ARTIFICIAL INTELLIGENCE CONTENT

(71) Applicant: NewsRx, LLC, Atlanta, GA (US)

(72) Inventors: Charles W. Henderson, Atlanta, GA (US); Alan D. Henderson, Watkinsville, GA (US); Chantay P. Jones, Marietta, GA (US); Kalani K. Rosell, New Haven, CT (US)

(21) Appl. No.: 15/365,059

(22) Filed: Nov. 30, 2016

(51) Int. Cl. G06N 5/02

(52) U.S. Cl. CPC G06N 5/022

(57) ABSTRACT

Technologies are described herein for identifying artificial intelligence content. According to some examples, content received is analyzed to determine if the content was generated by an artificial intelligence source. Upon identifying that the content was generated by an artificial intelligence source, the content is displayed in a manner that indicates the determination.

### BACKGROUND

Content provided by artificial intelligence sources is becoming more prevalent. From reports generated by financial information to news created from current events, content generated by an artificial intelligent source is increasingly being relied on by various businesses to provide content.

It is with respect to these and other considerations that the disclosure made herein is presented.

### SUMMARY

Technologies are described herein for identifying artificial intelligence content. Generally described, an artificial intelligence (“AI”) content identification system receives content from one or more content providers. Content can be information such as text from web pages, video, documents, speech or aural input, and the like. The AI content identification system analyzes at least a portion of the content received from the one or more content providers to determine if the portion of the content is content generated by an artificial intelligence source.

If the portion analyzed is determined to have been generated by an artificial intelligence source, the content as displayed on a content viewer application is modified to indicate the determination that the portion analyzed was generated by an artificial intelligence source. If determined to be content generated from an artificial intelligence source, the source of the content can be added to an artificial intelligence source list.

In some examples, the content identification system can be trained to detect misidentified or misconstrued content. For example, the content identification system can retrieve multiple instances of content provided by a content provider (such as a news reporter or individual), analyze the content to determine patterns, and then apply those patterns to other content identified as being from the content provider. If the patterns do not match or are substantially similar, the content identification system can provide an output that identifies the content as possibly being from a different content provider than the content provider listed.

In further examples, the content identification system can receive content from a content provider, scrub the content to determine one or more facts, then use those facts to search for content from other content providers that have provided content that matches or is substantially similar to the facts of the original content. If the facts are not matched or are substantially similar, the content identification system can provide an output that identifies the content as possibly being false or incorrect.

As used herein, “artificial intelligence” content is content constructed, written, or otherwise created by an artificial intelligence source. “Artificial intelligence” is broadly defined to be a computing source configured to operate fully or partially autonomously to generate content. It should be appreciated that the above-described subject matter can be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an artificial intelligence content identification system.

FIGS. 2A-2C are screen diagrams showing an illustrative graphical user interface that is configured with graphical elements for identifying artificial intelligence content.

FIGS. 3A-3C are screen diagrams showing an illustrative graphical user interface displaying search results modified to indicate the presence of content generated by an artificial intelligence source in the search results.

FIG. 4 is a flow diagram showing a routine illustrating aspects of a mechanism disclosed herein for identifying artificial intelligence content

FIG. 5 is a computer architecture diagram illustrating an illustrative computer hardware and software architecture for a computing system capable of implementing the technologies presented herein.

### DETAILED DESCRIPTION

The following detailed description is directed to technologies for analyzing content, including identifying artificial intelligence content. Content providers, such as news agencies or news aggregators, are increasingly reliant on content provided by artificial intelligence sources. The artificial intelligence sources can be more cost effective and timely than human sources. However, the use of artificial intelligence can create issues. For example, readers of content may believe that the content was written by a human, not knowing that the content was generated by an artificial intelligence source. In another example, the content may be identified as coming from a human source, but may have been generated in part (or in whole) by an artificial intelligence source.

The presently disclosed subject matter provides technologies that, among other uses, identify content as being provided by an artificial intelligence source. In several instances, it may be valuable for decision making to determine the source of content. For example, prior to artificial intelligence journalism, inherent bias and possibly misinformation can be determined by identifying the creator of the content. Thus, identifying content created by an artificial intelligence source, or identifying the source of content can allow better decision making capabilities in some instances.

While the subject matter described herein is presented in the general context of program modules that execute in conjunction with the execution of an operating system and application programs on a computer system, those skilled in the art will recognize that other implementations can be performed in combination with other types of program modules. Generally, program modules include routines, programs, components, data structures, and other types of structures that perform particular tasks or implement particular abstract data types. Moreover, those skilled in the art will appreciate that the subject matter described herein can be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific examples. Referring now to the drawings, aspects of technologies for identifying artificial intelligence content will be presented.

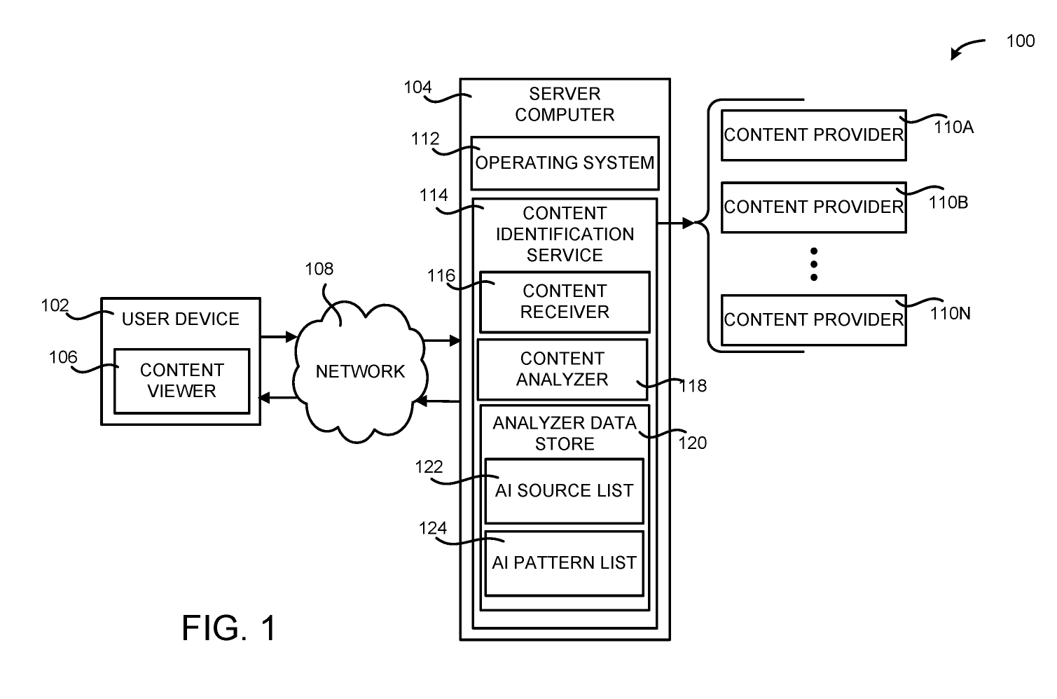

Referring now to FIG. 1, aspects of an identification system 100 for identifying artificial intelligence content is described. It should be noted herein that although the identification system 100 is described in relation to identifying artificial intelligence content, the identification system 100 can be used for other implementations. For example, the identification system 100 can be implemented to determine whether content identified as being authored by a person is actually provided by that person.

The identification system 100 shown in FIG. 1 includes a user device 102 and a server computer 104. According to various configurations, the functionality of the user device 102 or the server computer 104 can be provided by a personal computer (“PC”) such as a desktop, tablet, or laptop computer system. In some other configurations, the functionality of the user device 102 or the server computer 104 can be provided by other types of computing systems including, but not limited to, a handheld computer, a netbook computer, an embedded computer system, a mobile telephone, a smart phone, or another computing device.

Various aspects of the user device 102 or server computer 104 are illustrated and described below. Although the functionality of the user device 102 or the server computer 104 is primarily described herein as being provided by a tablet or slate computing device, a smartphone, or a PC having a touch-sensitive display, because the functionality described herein with respect to the user device 102 or server computer 104 can be provided by additional and/or alternative devices, it should be understood that these examples are illustrative, and should not be construed as being limiting in any way.

In some examples, the user device 102 receives input (e.g. from a user) to view content within a content viewer 106. In some examples, the content viewer 106 receives content and provides a viewing platform. For example, the content viewer 106 can be a word processing program in which documents can be viewed on the user device 102. In other examples, the content viewer 106 can be an Internet browser. In some examples, the content viewer 106 can be an application or “app” that is executed by an Internet browser. The presently disclosed subject matter is not limited to any particular type of content viewer 106.

The user device 102 is in communication with the server computer 104 through a network 108. The server computer 104 is configured to provide functionality for detecting and identifying artificial intelligence content provided by content providers, such as content providers 110A-110N (hereinafter referred to generally as “the content providers 110” and individually as “the content provider 110A,” “the content provider 110B,” and so forth). The content providers 110 can include Internet websites or a source of data, a source of video, a source of text, a source of audio, and the like. The presently disclosed subject matter is not limited to any particular type of content provider 110. It should also be understood that various aspects of the presently disclosed subject matter can be performed wholly or partially on other devices, such as another server computer (not shown). The server computer 104 can be configured to execute an operating system 112. The operating system 112 is a computer program for controlling the operation of the server computer 104.

In some examples, the server computer executes the operating system 112 to execute a content identification service 114. The content identification service 114 is configured to provide various functions. In some examples, the content identification service 114 receives an input from the content viewer 106 to analyze content to be displayed using the user device 102. The content identification service 114 receives the content from the content provider, such as the content provider 110A. the content can be from various sources, such as news agencies. For example, the content can be news stories aggregated from one or more sources of news content.

The content identification service 114 invokes a content receiver 116 to receive the content from the content provider 110A. The content receiver 116 can be a data store configured to receive and store content. Upon receiving the content, the content is provided to a content analyzer 118. The content analyzer 118 analyzes the content to determine, in some examples, if all or a portion of the content is content provided by an artificial intelligence source. In some examples, information stored in an analyzer data store 120 can be used in the determination.

Technologies for determining whether content is provided by an artificial intelligence source can vary. For example, one or more of the content providers 110 may have been previously identified as artificial intelligence sources. An artificial intelligence (AI) source list 122 can be stored within the analyzer data store 120. The AI source list 122 can include a listing of one or more content providers that have been previously identified as artificial intelligence sources of content. Thus, the content analyzer 118 can compare the identification of the content provider 110 against the content providers listed in the AI source list 122. If the content provider 110 is included in the list, the content analyzer can send an input to the content identification service 114 indicating that finding.

In another example, the analyzer data store 120 may have stored therein an AI pattern list 124. The AI pattern list 124 includes words or phrases, as well as other information, that indicates the presence of artificial intelligence content. For example, content generated by an artificial intelligence source may not be provided through a particular content provider 110, but rather, may be released through various content providers 110.

In this example, the AI pattern list 124 may have stored therein one or more patterns that can be used to identify an artificial intelligence source. By analyzing various forms of content known to be from artificial intelligence sources, the AI pattern list 124 may have stored therein one or more patterns that are found in the analyzed content. For example, the content analyzer 118 may have analyzed a million news articles from one or more known artificial intelligence sources. After the analysis, the content analyzer 118 may have determined a pattern found in several of the analyzed content.

For example, the content analyzer 118 may have determined that the analyzed artificial intelligence content uses sentences in a “subject-verb-object” order in over fifty percent of the sentences contained within the content. Thus, a pattern stored in the AI pattern list 124 may be the order of the sentences at a particular rate within the content. Another example may be the use of a particular adjective across content from a particular source. For example, an artificial intelligence content provider may be programmed to use “powerful” in relation to a homerun in an article about a baseball game. The AI pattern list 124 may have stored therein that pattern as being a pattern associated with artificial intelligence content. These and other examples of patterns are included within the scope of the presently disclosed subject matter.

In another example, the content analyzer 118 may deconstruct content and attempt to reconstruct the content using one or more known methods of generating artificial intelligence content. The content analyzer 118 may then compare the original content with the reconstructed content. If the original content matches or is similar to the reconstructed content, then the content analyzer 118 may determine that the content is provided by an artificial intelligence source. In these examples, the AI pattern list 124 may have stored therein one or more methods of generating artificial intelligence content. When comparing content, the comparison may be done using tools similar to a plagiarism checker used to check for plagiarism in college papers.

In another example, as briefly mentioned above, the content analyzer 118 can also be used to determine the validity of content. For example, a search on many news aggregators, search engines, or social media portals may return content that is untrue or fake. The AI pattern list 124 may include patterns identified as being associated with sources that release incorrect information.

In another example, the content analyzer 118 can also access one or more of the content providers 110 and compare information in the content being analyzed with information received from the one or more content providers 110. For example, the content received from content provider 110A can be a news story discussing an exploding building. The content analyzer 118 can access content providers 110B-110N to verify the information. For example, the content provider 110B can be a competing news organization.

In another example, the content provider 110N can be a governmental source of information (such as a police database), whereby the explosion of a building would likely cause data to be stored in the governmental source of information. It should be noted that the above are merely examples, as other means of verifying information can be used and would be considered to be within the scope of the presently disclosed subject matter.

Returning to the example of analyzing for AI content, if the content analyzer 118 determines that the content received and analyzed is not content provided by an artificial intelligence source, the content analyzer 120 transmits a “no artificial intelligence detected” output to the content identification service 114. The content identification service 114 thereafter causes or allows the content to be provided to the content viewer 106 in the user device 102. If the content analyzer 118 determines that the content received and analyzed is in whole or in part content provided by an artificial intelligence source, the content analyzer 120 transmits an “artificial intelligence detected” output to the content identification service 114. In some examples, the content analyzer 118 can also identify the particular portion of the content containing the artificial intelligence content. The content identification service 114, after receiving the “artificial intelligence detected” can either cause the content from being received by the content viewer 106, thus acting as a filtering service, or provide an output that changes the appearance of the portion of the content identified as being generated from an artificial intelligence source.

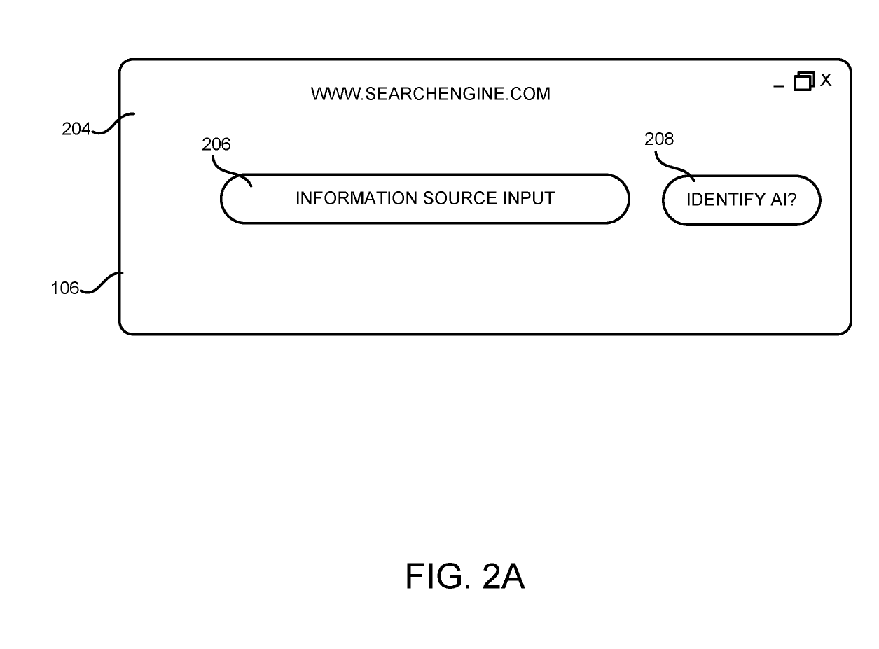

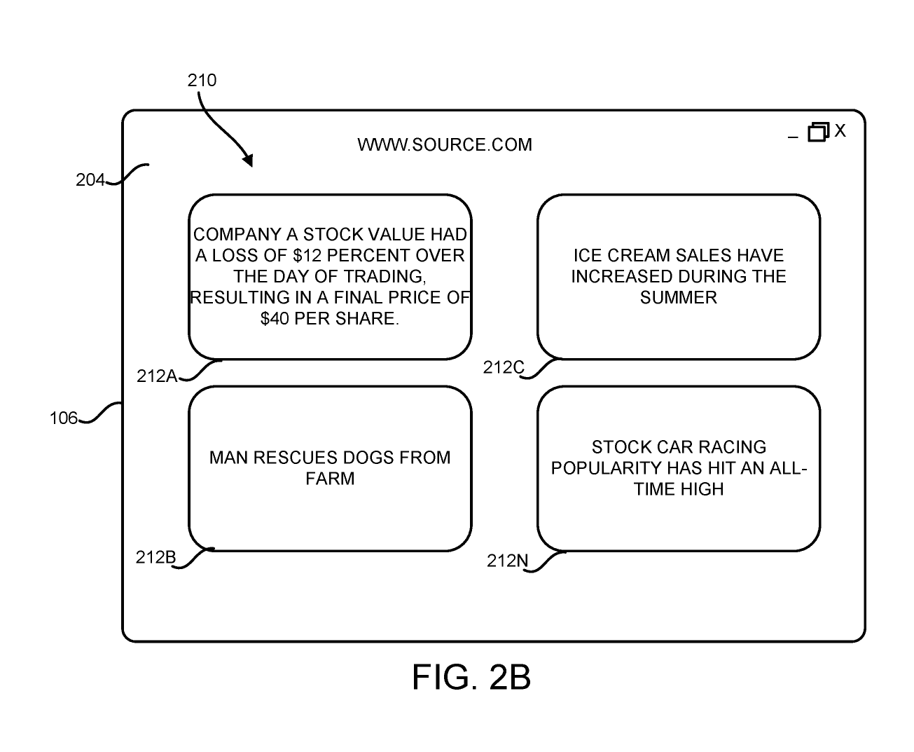

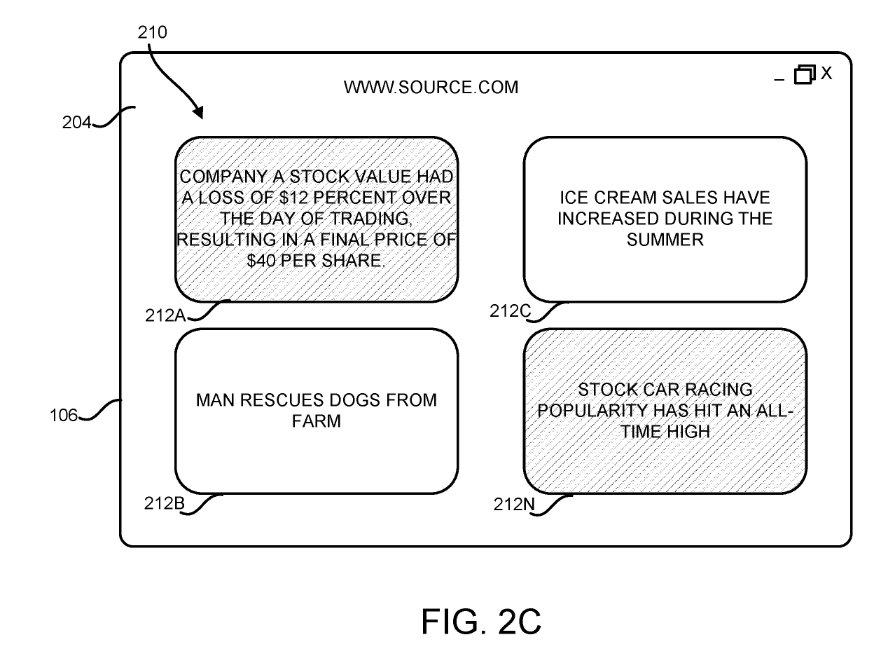

FIGS. 2A-2C are screen diagrams showing the identification system 100 in use. In FIG. 2A, a search interface 204 displayed in the content viewer 106 on the user device 102. In FIG. 2A, the content viewer 106 is an Internet browser. The search interface 204 includes a search input 206. The search input 206 may be one or more terms, a filter, or other manner in which a user may initiate a search for content. In some examples, a user may specifically request content generated by an artificial intelligence source, or the content generated by an artificial intelligence source may be provided without the knowledge of a user (or other system or entity). The search interface 204 includes an identify AI input request 208. The identify AI input request 208 can receive an input request that initiates the content identification service 114 if content is received.

FIG. 2B is the content viewer 106 without an indication of artificial intelligence content. The content 210 includes content portions 212A-212N. The content portions 212A-212N can be various types of information. For example, the content portion 212A can be a news article from a news source. The content portion 212B can be an audio file. The content portion 212C can be a video file. The content portion 212N can be an advertisement. These and other types of content portions are considered to be within the scope of the presently disclosed subject matter. If the content identification service 114 identifies that one or more of the content portions 212A-212N are content generated from an artificial intelligence source, the visual appearance of the content portions 212A-212N so identified can be modified (or another means of notification may be used).

FIG. 2C is the content viewer 106 with an indication of artificial intelligence content. In the example illustrated in FIG. 2C, the content portion 212A and the content portion 212N are changed using a cross hatch pattern to identify the content portions 212A and 212N as being content from an artificial intelligence source.

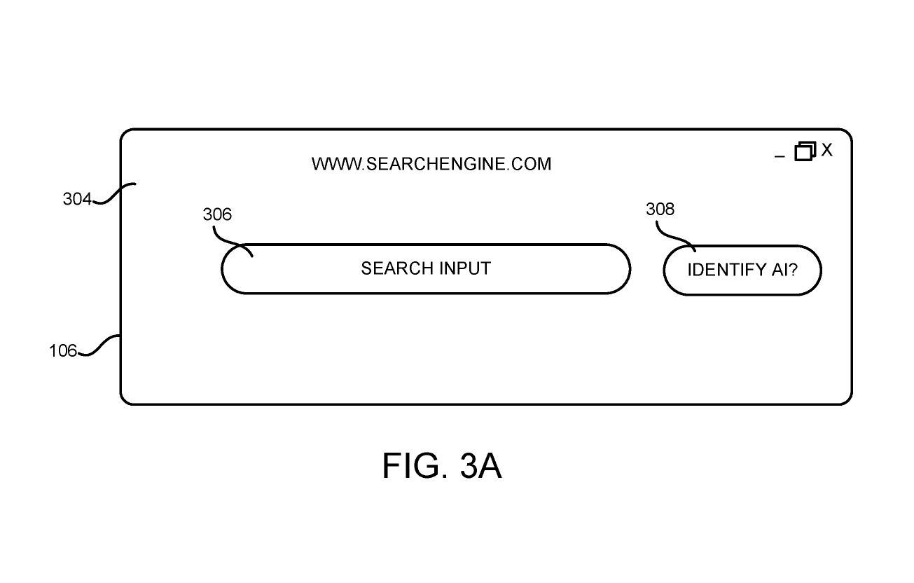

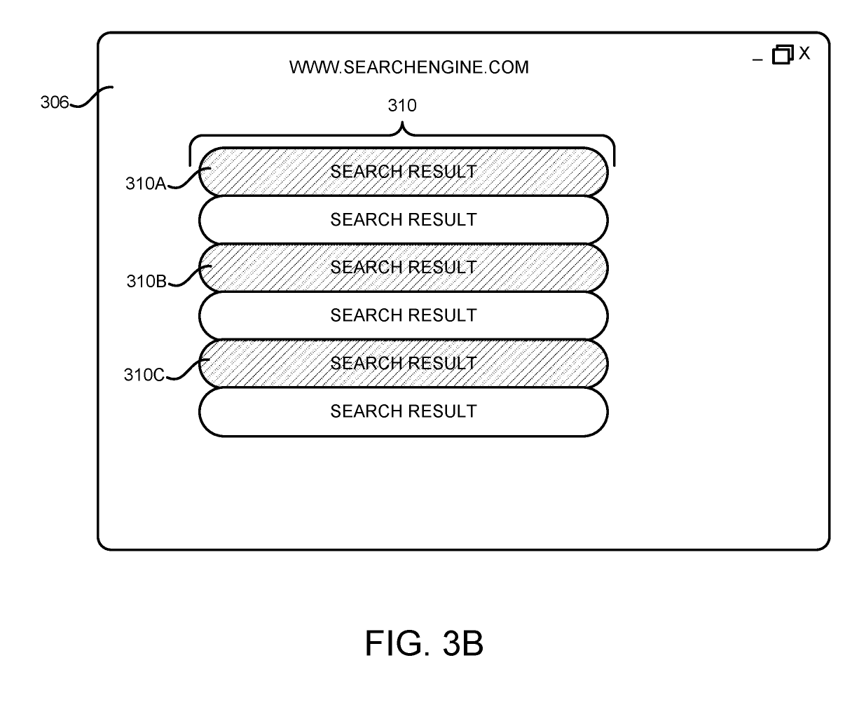

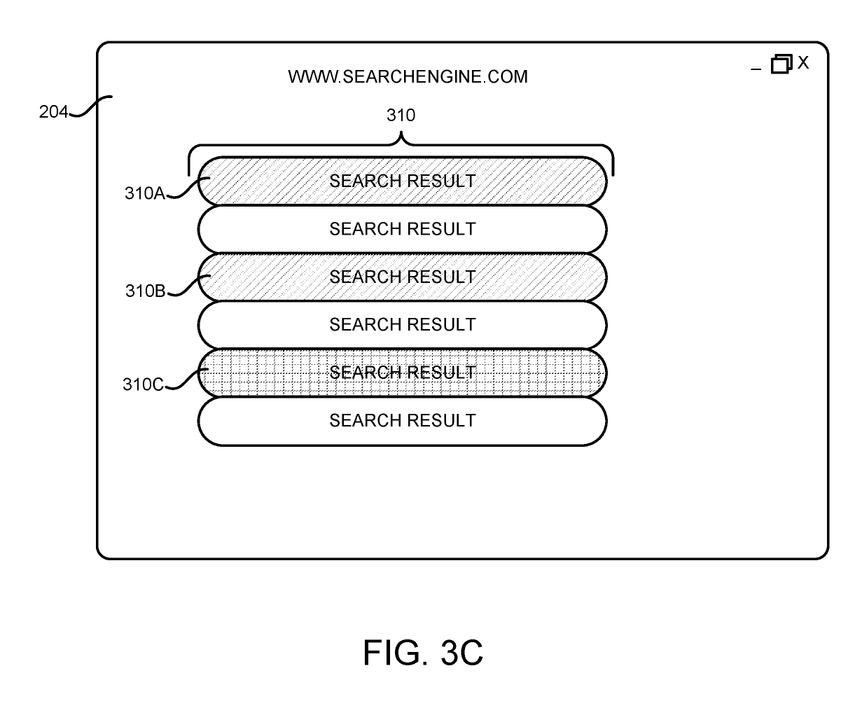

FIGS. 3A-3C are screen diagrams showing the identification system 100 used in conjunction with a search function. In FIG. 3A, a search interface 304 displayed in the content viewer 106 on the user device 102. In FIG. 3A, the content viewer 106 is an Internet browser. The search interface 304 includes a search input 306. The search input 306 may be one or more terms, a filter, or other manner in which a user may initiate a search for content.

In some examples, a user may specifically request content generated by an artificial intelligence source, or the content generated by an artificial intelligence source may be provided without the knowledge of a user (or other system or entity). The search interface 304 includes an identify AI input request 308. The identify AI input request 308 can receive an input request that initiates the content identification service 114 if content is received.

FIG. 3B is the search interface 204 after search results 310 are received. The content analyzer 118 can analyze the search results to determine which of the search results 310 contain content from an artificial intelligence source. For example, search results 310A, 310B, and 310C are displayed with cross hatch patterns to indicate the artificial intelligence content.

FIG. 3C is the search interface after the search results 310 are received in a different configuration. In FIG. 3C, the percentage of artificial intelligence content is indicated. For example, the search result 310A may be a link to a news aggregation website. The content analyzer 118 may have determined that less than five percent (or another threshold) of the content from the search result 310A is provided by an artificial intelligence source. The content analyzer 118 may have made the same determination with regard to search result 310B.

However, the content analyzer 118 may have determined that the search result 310C includes content that is almost entirely content provided by an artificial intelligence source. Thus, search result 310C may be displayed in a different fashion than the other search results 310 having a lower percentage of content provided by an artificial intelligence source.

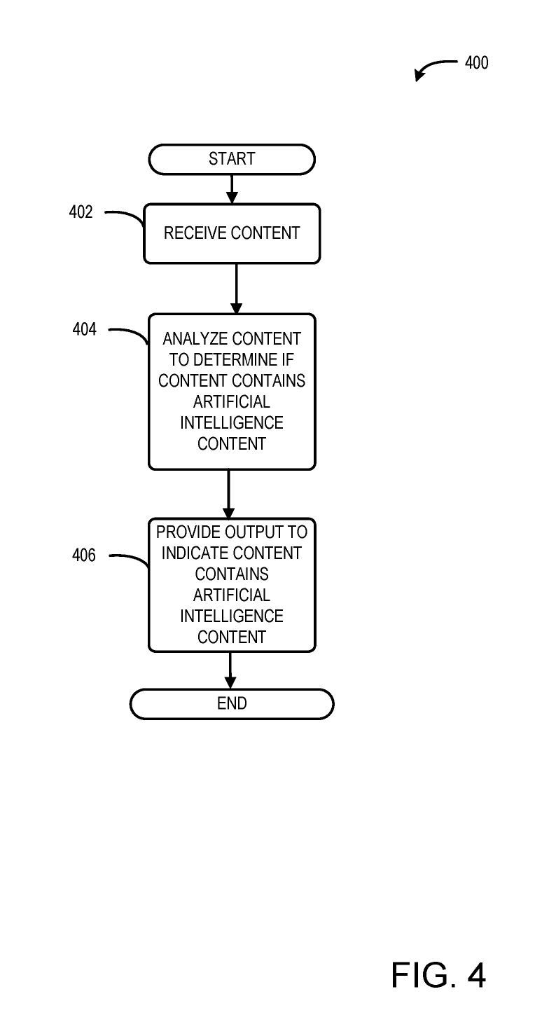

FIG. 4 is a flow diagram showing aspects of a method 400 disclosed herein for identifying artificial intelligence content. It should be understood that the operations of the method 400 are not necessarily presented in any particular order and that performance of some or all of the operations in an alternative order(s) is possible and is contemplated. The operations have been presented in the demonstrated order for ease of description and illustration. Operations can be added, omitted, and/or performed simultaneously, without departing from the scope of the appended claims.

It also should be understood that the illustrated method 400 can be ended at any time and need not be performed in its entirety. Some or all operations of the method 400, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Computer-storage media does not include transitory media.

Thus, it should be appreciated that the logical operations described herein can be implemented as a sequence of computer implemented acts or program modules running on a computing system, and/or as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules can be implemented in software, in firmware, in special purpose digital logic, and any combination thereof.

For purposes of illustrating and describing the technologies of the present disclosure, the method 400 disclosed herein is described as being performed by the server computer 104 via execution of computer executable instructions such as, for example, the content identification service 114. As explained above, the content identification service 114 can include functionality for identifying artificial intelligence content. While the method 400 is described as being provided by the server computer 104, it should be understood that the server computer 104 and/or the user device 102 can provide the functionality described herein via execution of various application program modules and/or elements. Additionally, devices other than, or in addition to, the server computer 104 can be configured to provide the functionality described herein via execution of computer executable instructions other than, or in addition to, the content identification service 114. As such, it should be understood that the described configuration is illustrative, and should not be construed as being limiting in any way.

The method 400 begins at operation 402, where the content is received. The content can be received from various sources as a result of various operations. For example, the content can be received from one or more content providers 110 as a result of an Internet search, whereby the content viewer is an Internet browser 106.

The method 400 continues to operation 404, where the content is analyzed to determine if a portion of the content includes content provided by an artificial intelligence source. In some examples, the content identification service 114 can have access to the AI source list 122. The AI source list 122 can include one or more listings of content providers 110 that are known to be sources of artificial intelligence content. The AI source list 122 can include identifying information such as organizations, a uniform resource locator, internet protocol addresses, and the like.

The content identification service 114 can also have access to the AI pattern list 124. The AI pattern list 124 can include one or more patterns that have been determined to be associated with artificial intelligence content. For example, it may have been determined that content having at least 60% of the sentences in “subject-verb-object” format is artificial intelligence content. In other examples, the AI pattern list 124 can include terms or phrases that are known to be used by artificial intelligence sources.

In some examples, the AI pattern list 124 can include previously recorded patterns for sources listed in the AI source list 122. The content analyzer 118 can analyze content provided by a source, retrieve patterns associated with the source stored in the AI pattern list 124, and determine if the pattern of the content match (or are similar to) the patterns associated with the source stored in the AI pattern list 124. If the patterns from the content and the stored patterns do not match, the content analyzer 118 can provide an output indicating that the content does not appear to be content normally output by the source.

The method 400 continues to operation 406, where an output is provided if the content analyzer 118 determines that the content, either a portion or the content itself, contains artificial intelligence content. The output can vary. For example, the output can be to change how the content is displayed by the content viewer 106. In other examples, the output can be to remove the content determined to be artificial intelligence content, such as a filter. The output can also include an indication as to how much (or the percentage) of the content is content generated by an artificial intelligence source. The method 400 can thereafter end.

The present disclosure also encompasses the subject matter set forth in the following clauses:

Clause 1: A computer-implemented method, the method comprising receiving content generated by one or more content providers, determining that the content is generated by an artificial intelligence source, and generating an output to change how the content is displayed in a content viewer.

Clause 2. The computer-implemented method of clause 1, wherein determining that the content is content generated by an artificial intelligence source comprises accessing an artificial intelligence source list comprising a listing of artificial intelligence sources, determining the source of the content, comparing the source of the content against the artificial intelligence source list, and determining that the source of the content is from one of the artificial intelligence sources.

Clause 3. The computer-implemented method of any of clauses 1-2, wherein determining that the content is content generated by an artificial intelligence source comprises accessing an artificial intelligence pattern list comprising a listing of patterns determined to indicate an artificial intelligence source, analyzing the content to determine a pattern, comparing the pattern of the content against the artificial intelligence pattern list, and determining that the pattern of the content matches at least one of the patterns determined to indicate an artificial intelligence source.

Clause 4. The computer-implemented method of any of clauses 1-3, wherein the content provider comprises an Internet website.

Clause 5. The computer-implemented method of any of clauses 1-4, wherein the content provider comprises a source of data, a source of video, a source of text, or a source of audio.

Clause 6. The computer-implement method of any of clauses 1-5, wherein the content viewer comprises an Internet browser.

Clause 7. The computer-implement method of any of clauses 1-6, wherein the content viewer comprises a word processing program or an application executed by an Internet browser.

Clause 8. The computer-implement method of any of clauses 1-7, further comprising an output to indicate a percentage of the content that is artificial intelligence content.

Clause 9. A computer-readable storage medium having computer-executable instructions stored thereupon that, when executed by a computer, cause the computer to receive content generated by one or more content providers, determine that the content is generated by an artificial intelligence source, and generate an output to change how the content is displayed in a content viewer.

Clause 10. The computer-readable storage medium of clause 9, wherein the computer-executable instructions to determine that the content is content generated by an artificial intelligence source comprises computer-executable instructions to: access an artificial intelligence source list comprising a listing of artificial intelligence sources; determine a source of the content; compare the source of the content against the artificial intelligence source list; and determine that the source of the content is from one of the artificial intelligence sources.

Clause 11. The computer-readable storage medium of any of clauses 9-10, wherein the source comprises a uniform resource locator, an organization, or an internet protocol address.

Clause 12. The computer-readable storage medium of any of clauses 9-11, wherein the computer-executable instructions to determine that the content is content generated by an artificial intelligence source comprises computer-executable instructions to: access an artificial intelligence pattern list comprising a listing of patterns determined to indicate an artificial intelligence source; analyze the content to determine a pattern; compare the pattern of the content against the artificial intelligence pattern list; and determine that the pattern of the content matches at least one of the patterns determined to indicate an artificial intelligence source.

Clause 13. The computer-readable storage medium of any of clauses 9-12, wherein the content provider comprises an Internet website.

Clause 14. The computer-readable storage medium of any of clauses 9-13, wherein the content provider comprises a source of data, a source of video, a source of text, or a source of audio.

Clause 14. The computer-readable storage medium of any of clauses 9-13, wherein the search query comprises an image or video.

Clause 15. The computer-readable storage medium of any of clauses 9-14, wherein the content viewer comprises an Internet browser.

Clause 16. The computer-readable storage medium of any of clauses 9-15, wherein the content viewer comprises a word processing program or an application executed by an Internet browser.

Clause 17. The computer-readable storage medium of any of clauses 9-16, further comprising computer-executable instructions to generate an output to indicate a percentage of the content that is artificial intelligence content.

Clause 18. A system comprising: a processor; and a computer-readable storage medium in communication with the processor, the computer-readable storage medium having computer-executable instructions stored thereupon which, when executed by the processor, cause the processor to receive content generated by one or more content providers, determine that the content is generated by an artificial intelligence source, and generate an output to change how the content is displayed in a content viewer.

Clause 19. The system of clause 18, wherein the computer-executable instructions to determine that the content is content generated by an artificial intelligence source comprises computer-executable instructions to: access an artificial intelligence source list comprising a listing of artificial intelligence sources to determine that the source of the content is from one of the artificial intelligence source; and access an artificial intelligence pattern list comprising a listing of patterns determined to indicate an artificial intelligence source to determine that the pattern of the content matches at least one of the patterns determined to indicate an artificial intelligence source.

Clause 20. The system of any of clauses 18-19, further comprising computer-executable instructions to generate an output to indicate a percentage of the content that is artificial intelligence content.

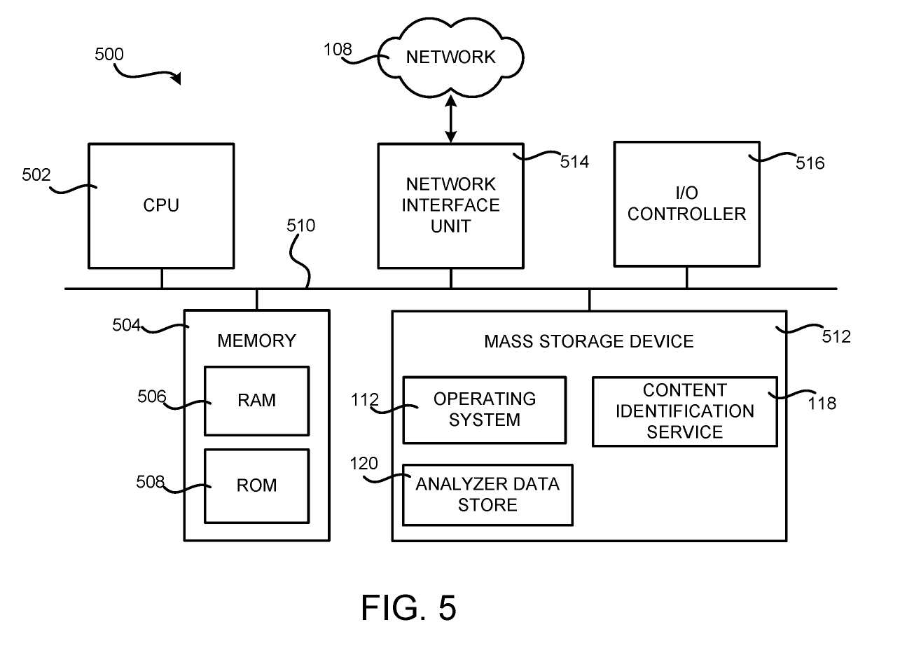

FIG. 5 illustrates an illustrative computer architecture 500 for an artificial intelligence identification described herein. Thus, the computer architecture 500 illustrated in FIG. 5 illustrates an architecture for a server computer, mobile phone, a smart phone, a desktop computer, a netbook computer, a tablet computer, and/or a laptop computer. The computer architecture 500 can be utilized to execute any aspects of the software components presented herein.

The computer architecture 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between elements within the computer architecture 500, such as during startup, is stored in the ROM 508. The computer architecture 500 further includes a mass storage device 512 for storing the operating system 112 and one or more application programs or data stores including, but not limited to, the content identification service 114, the content receiver 116, the content analyzer 118, and the analyzer data store 120.

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media can include volatile and non-volatile, removable and non-removable media implemented in any method or technology for storage of information such as computer-readable instructions, data structures, program modules or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 500. For purposes the claims, a “computer storage medium” or “computer-readable storage medium,” and variations thereof, do not include waves, signals, and/or other transitory and/or intangible communication media, per se. For the purposes of the claims, “computer-readable storage medium,” and variations thereof, refers to one or more types of articles of manufacture.

According to various configurations, the computer architecture 500 can operate in a networked environment using logical connections to remote computers through a network such as the network 108. The computer architecture 500 can connect to the network 108 through a network interface unit 514 connected to the bus 510. It should be appreciated that the network interface unit 514 can also be utilized to connect to other types of networks and remote computer systems. The computer architecture 500 can also include an input/output controller 516 for receiving and processing input from a number of other devices, including a keyboard, mouse, or electronic stylus (not shown in FIG. 5). Similarly, the input/output controller 516 can provide output to a display screen, a printer, or other type of output device (also not shown in FIG. 5).

It should be appreciated that the software components described herein can, when loaded into the CPU 502 and executed, transform the CPU 502 and the overall computer architecture 500 from a general-purpose computing system into a special-purpose computing system customized to facilitate the functionality presented herein. The CPU 502 can be constructed from any number of transistors or other discrete circuit elements, which can individually or collectively assume any number of states. More specifically, the CPU 502 can operate as a finite-state machine, in response to executable instructions contained within the software modules disclosed herein. These computer-executable instructions can transform the CPU 502 by specifying how the CPU 502 transitions between states, thereby transforming the transistors or other discrete hardware elements constituting the CPU 502.

Encoding the software modules presented herein can also transform the physical structure of the computer-readable media presented herein. The specific transformation of physical structure can depend on various factors, in different implementations of this description. Examples of such factors can include, but are not limited to, the technology used to implement the computer-readable media, whether the computer-readable media is characterized as primary or secondary storage, and the like. For example, if the computer-readable media is implemented as semiconductor-based memory, the software disclosed herein can be encoded on the computer-readable media by transforming the physical state of the semiconductor memory. For example, the software can transform the state of transistors, capacitors, or other discrete circuit elements constituting the semiconductor memory. The software also can transform the physical state of such components in order to store data thereupon.

As another example, the computer-readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 500 in order to store and execute the software components presented herein. It also should be appreciated that the computer architecture 500 can include other types of computing devices, including hand-held computers, embedded computer systems, personal digital assistants, and other types of computing devices known to those skilled in the art. It is also contemplated that the computer architecture 500 might not include all of the components shown in FIG. 5, can include other components that are not explicitly shown in FIG. 5, or might utilize an architecture completely different than that shown in FIG. 5.

Based on the foregoing, it should be appreciated that technologies for identifying artificial intelligence content have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes can be made to the subject matter described herein without following the example configurations and applications illustrated and described, and without departing from the true spirit and scope of the present invention, aspects of which are set forth in the following claims.

What is claimed is:

1. A computer-implemented method, the method comprising:
receiving content generated by one or more content providers;
determining that the content is generated by an artificial intelligence source; and
generating an output to change how the content is displayed in a content viewer.

2. The computer-implemented method of claim 1, wherein determining that the content is content generated by an artificial intelligence source comprises:
accessing an artificial intelligence source list comprising a listing of artificial intelligence sources;
determining a source of the content;
comparing the source of the content against the artificial intelligence source list; and
determining that the source of the content is from one of the artificial intelligence sources.

3. The computer-implemented method of claim 1, wherein determining that the content is content generated by an artificial intelligence source comprises:
accessing an artificial intelligence pattern list comprising a listing of patterns determined to indicate an artificial intelligence source;
analyzing the content to determine a pattern;
comparing the pattern of the content against the artificial intelligence pattern list; and
determining that the pattern of the content matches at least one of the patterns determined to indicate an artificial intelligence source.

4. The computer-implemented method of claim 1, wherein the content provider comprises an Internet website.

5. The computer-implemented method of claim 1, wherein the content provider comprises a source of data, a source of video, a source of text, or a source of audio.

6. The computer-implemented method of claim 1, wherein the content viewer comprises an Internet browser.

7. The computer-implemented method of claim 1, wherein the content viewer comprises a word processing program or an application executed by an Internet browser.

8. The computer-implemented method of claim 1, further comprising an output to indicate a percentage of the content that is artificial intelligence content.

9. A computer-readable storage medium having computer-executable instructions stored thereupon that, when executed by a computer, cause the computer to:
receive content generated by one or more content providers;
determine that the content is generated by an artificial intelligence source; and
generate an output to change how the content is displayed in a content viewer.

10. The computer-readable storage medium of claim 9, wherein the computer-executable instructions to determine that the content is content generated by an artificial intelligence source comprises computer-executable instructions to:
access an artificial intelligence source list comprising a listing of artificial intelligence sources;
determine a source of the content;
compare the source of the content against the artificial intelligence source list; and
determine that the source of the content is from one of the artificial intelligence sources.

11. The computer-readable storage medium of claim 10, wherein the source comprises a uniform resource locator, an organization, or an internet protocol address.

12. The computer-readable storage medium of claim 9, wherein the computer-executable instructions to determine that the content is content generated by an artificial intelligence source comprises computer-executable instructions to:
access an artificial intelligence pattern list comprising a listing of patterns determined to indicate an artificial intelligence source;
analyze the content to determine a pattern;
compare the pattern of the content against the artificial intelligence pattern list; and
determine that the pattern of the content matches at least one of the patterns determined to indicate an artificial intelligence source.

13. The computer-readable storage medium of claim 9, wherein the content provider comprises an Internet website.

14. The computer-readable storage medium of claim 9, wherein the content provider comprises a source of data, a source of video, a source of text, or a source of audio.

15. The computer-readable storage medium of claim 9, wherein the content viewer comprises an Internet browser.

16. The computer-readable storage medium of claim 9, wherein the content viewer comprises a word processing program or an application executed by an Internet browser.

17. The computer-readable storage medium of claim 9, further comprising computer-executable instructions to generate an output to indicate a percentage of the content that is artificial intelligence content.

18. A system comprising:
a processor; and
a computer-readable storage medium in communication with the processor, the computer-readable storage medium having computer-executable instructions stored thereupon which, when executed by the processor, cause the processor to
receive content generated by one or more content providers,
determine that the content is generated by an artificial intelligence source, and
generate an output to change how the content is displayed in a content viewer.

19. The system of claim 18, wherein the computer-executable instructions to determine that the content is content generated by an artificial intelligence source comprises computer-executable instructions to:
access an artificial intelligence source list comprising a listing of artificial intelligence sources to determine that the source of the content is from one of the artificial intelligence source; and
access an artificial intelligence pattern list comprising a listing of patterns determined to indicate an artificial intelligence source to determine that the pattern of the content matches at least one of the patterns determined to indicate an artificial intelligence source.

20. The system of claim 18, further comprising computer-executable instructions to generate an output to indicate a percentage of the content that is artificial intelligence content.
